(19) United States
(12) Patent Application Publication
(10) Pub. No.: US 2026/0274479 A1
(43) Pub. Date: Sep. 17, 2026

(54) INTEGRATED CONVEYOR SYSTEM FOR EFFICIENT AND AUTOMATED HANDLING OF PARTICULATE MATERIALS FROM BELLY DUMP TRAILERS

(71) Applicant: Belly2Box LLC, Midland, TX (US)

(72) Inventor: Nathaniel M. Harris, Midland, TX (US)

(21) Appl. No.: 19/445,466

(22) Filed: Jan. 9, 2026

Related U.S. Application Data
(60) Provisional application No. 63/743,252, filed on Jan. 9, 2025.

(51) Int. Cl. B65B 37/00; B65B 1/06; B65B 1/28; B65B 57/14; B65G 37/00; B65G 41/00; B65G 43/08; B65G 47/18; B65G 47/44; B65G 47/51; B65G 69/18; G08G 1/095

(52) U.S. Cl. CPC B65B 37/005; B65B 1/06; B65B 1/28; B65B 57/145; B65G 37/00; B65G 41/002; B65G 43/08; B65G 47/18; B65G 47/44; B65G 47/5195; B65G 69/188; G08G 1/095; B65G 2201/042; B65G 2203/0241; B65G 2811/095

(57) ABSTRACT

A system is provided for unloading particulate material from a belly dump trailer. The system includes a roadway having an integrated grate, a first conveyor positioned beneath the grate to receive and convey particulate material to a discharge end, and a second conveyor positioned to receive material from the first conveyor and convey it to a discharge end. A plurality of containers is arranged to receive particulate material discharged from the second conveyor. The system further includes a rotational mechanism configured to rotate at least a portion of the second conveyor about an axis to selectively position its discharge end over a chosen container.

### CROSS-REFERENCE TO RELATED APPLICATIONS

This application claims the benefit of U.S. provisional application No. 63/743,252 filed Jan. 9, 2025, having the same title and the same inventor, and which is incorporated herein by reference in its entirety.

### FIELD OF THE DISCLOSURE

The present disclosure relates generally to the field of bulk material handling and transportation, and more particularly to systems for efficiently unloading particulate materials (such as gravel, sand, or other aggregates) from belly dump trailers.

### BACKGROUND OF THE DISCLOSURE

Belly dump trailers, also known as bottom dump trailers, are specialized transport vehicles designed for the efficient handling and unloading of bulk materials such as gravel, sand, asphalt, or agricultural products. These trailers are characterized by a unique design that features a hopper-like container with an opening mechanism at the bottom, commonly referred to as “belly gates.” This design allows materials to be discharged directly onto the ground or into a designated area by simply opening the belly gates, leveraging gravity for quick and efficient unloading.

Belly dump trailers are typically constructed with durable materials such as steel or aluminum to withstand the abrasive nature of the materials they carry. They are equipped with multiple axles to support heavy loads and often feature mechanisms to control the flow of material, allowing operators to adjust the discharge rate and area coverage. These trailers are widely used in industries such as construction, mining, agriculture, and landscaping, where the efficient transportation and placement of bulk materials are essential. Their simplicity, versatility, and ability to unload without tilting make them a practical choice for many bulk hauling applications.

In traditional practices for unloading particulate materials from a belly dump trailer, the materials are typically discharged directly onto the ground, forming a large heap. While this method is straightforward, it introduces numerous inefficiencies and challenges. To transport the materials from the heap to their intended destinations, such as containers or processing equipment, auxiliary machinery such as backhoe loaders, skid steers, or crawler loaders is commonly required. This approach is labor-intensive, time-consuming, and fraught with several significant problems.

One major issue is material spillage and waste. When materials are dumped into an open heap, they are exposed to environmental factors such as wind and rain, which may lead to material loss, degradation or contamination. Additionally, the use of loaders to transfer materials often results in further spillage during handling, compounding the waste. The workflow itself is inefficient, as the sequential process of dumping, heaping, and relocating materials requires loaders to shuttle back and forth between the heap and the target containers or equipment. This not only prolongs the operation but also increases energy consumption.

The reliance on multiple loaders contributes to high equipment and maintenance costs. Frequent use of heavy machinery accelerates wear and tear, adding to operational expenses and reducing overall cost-effectiveness. These labor-intensive operations also demand additional personnel to operate the machinery and oversee the process, driving up labor costs and limiting scalability. Moreover, the exposed heap generates dust, posing health and environmental hazards, while the repetitive operation of heavy machinery in close proximity to workers increases the risk of workplace accidents.

Finally, these traditional methods lack precision. The manual transfer of materials often results in uneven distribution or overloading of containers, necessitating rework and causing further inefficiencies downstream.

### SUMMARY OF THE DISCLOSURE

In one aspect, a system is provided for unloading particulate materials from a belly dump trailer. The system comprises a roadway with a grate integrated therein; a first conveyor system, including (a) a first receiving end positioned under the grate for receiving particulate materials, (b) a first discharging end, and (c) a first conveyor belt for conveying particulate materials from the first receiving end to the first discharging end; a second conveyor system, including (a) a second receiving end positioned to receive particulate materials discharged from the first discharging end of the first conveyor system, (b) a second discharging end, and (c) a second conveyor belt for conveying particulate materials from the second receiving end to the second discharging end; a plurality of containers configured to receive particulate materials discharged from the second discharging end of the second conveyor system; and a rotational mechanism configured to rotate at least a portion of the second conveyor system along an axis to reposition the second discharging end of the second conveyor system over a selected one of the plurality of containers.

In another aspect, a method for unloading particulate materials from a belly dump trailer is provided. The method comprises discharging particulate materials from the belly dump trailer onto a roadway with a grate integrated therein; receiving the particulate materials through the grate at a first receiving end of a first conveyor system; conveying the particulate materials from the first receiving end to a first discharging end using a first conveyor belt; receiving the particulate materials at a second receiving end of a second conveyor system, the second receiving end positioned to receive particulate materials discharged from the first discharging end of the first conveyor system; conveying the particulate materials from the second receiving end to a second discharging end using a second conveyor belt; discharging the particulate materials from the second discharging end into a first of a plurality of containers; rotating at least a portion of the second conveyor system along an axis to reposition the second discharging end over a second of the plurality of containers; and discharging the particulate materials from the second discharging end into the second of the plurality of containers.

### BRIEF DESCRIPTION OF THE DRAWINGS

FIGS. 1-9 are illustrations of a system in accordance with the teachings herein for unloading particulate materials from a belly dump trailer and into a series of containers.

### DETAILED DESCRIPTION

Collectively, the various issues noted in the background section make conventional unloading practices inefficient, costly, and environmentally unsound. There is thus a need in the art for a more streamlined and automated solution.

It has now been found that some or all of the foregoing problems may be addressed with the systems and methodologies disclosed herein. In a preferred embodiment, these systems feature a roadway with a grate integrated therein over which the belly gates of a belly dump trailer may be positioned. A conveyor system is provided featuring first and second conveyor systems. The first conveyor system includes (a) a first receiving end positioned under the grate for receiving particulate materials from a belly dump trailer, (b) a first discharging end, and (c) a first conveyor belt for conveying particulate materials from the first receiving end to the first discharging end. The second conveyor system includes (a) a second receiving end positioned to receive particulate materials discharged from the first discharging end of the first conveyor system, (b) a second discharging end, and (c) a second conveyor belt for conveying particulate materials from the second receiving end to the second discharging end. A plurality of containers are positioned, on a loading dock or at another convenient location, to receive particulate materials discharged from the second discharging end of the second conveyor system. A rotational mechanism is provided which is configured to rotate the second conveyor system (or portion thereof) with respect to the first conveyor system along an axis to reposition it over a selected one of the plurality of containers. The first and second conveyor belts are preferably covered to shield their contents from the external environment and to reduce dust generation and material loss.

The foregoing embodiment addresses the challenges noted above by providing an integrated and automated system for unloading particulate materials from a belly dump trailer directly into containers via a series of conveyor systems. By positioning a grate over the first conveyor system, the materials are captured immediately upon discharge from the belly dump trailer, thus eliminating open heaps. This design thus ensures minimal material spillage, waste, and environmental exposure.

The first conveyor system efficiently transfers materials to a second conveyor system, which features a rotational mechanism at its discharging end. This mechanism allows the materials to be precisely directed into a selected one of a plurality of containers, providing greater control over the unloading process. By automating the transfer and placement of materials, the system eliminates the need for auxiliary loaders, significantly reducing equipment, maintenance, and labor costs.

Additionally, the enclosed design of the conveyor systems minimizes dust generation, addressing environmental and safety concerns. The streamlined workflow of this approach eliminates the repetitive back-and-forth movement of loaders, reducing unloading times and enhancing overall operational efficiency. Furthermore, the system allows for precise placement of materials into containers, thus reducing the likelihood of overloading or uneven distribution, and optimizing downstream processes.

By integrating these innovative features, preferred embodiments of the systems and methodologies disclosed herein offer highly efficient, cost-effective, and environmentally responsible solutions to the problems associated with traditional material handling practices. In doing so, they streamline the entire process, from unloading to containerization, while addressing the inefficiencies, safety risks, and environmental challenges of conventional approaches.

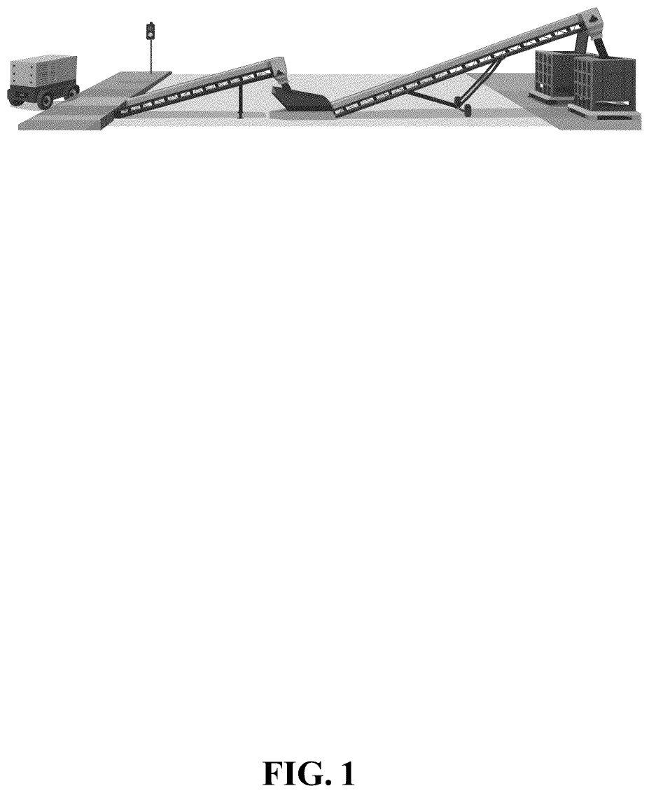

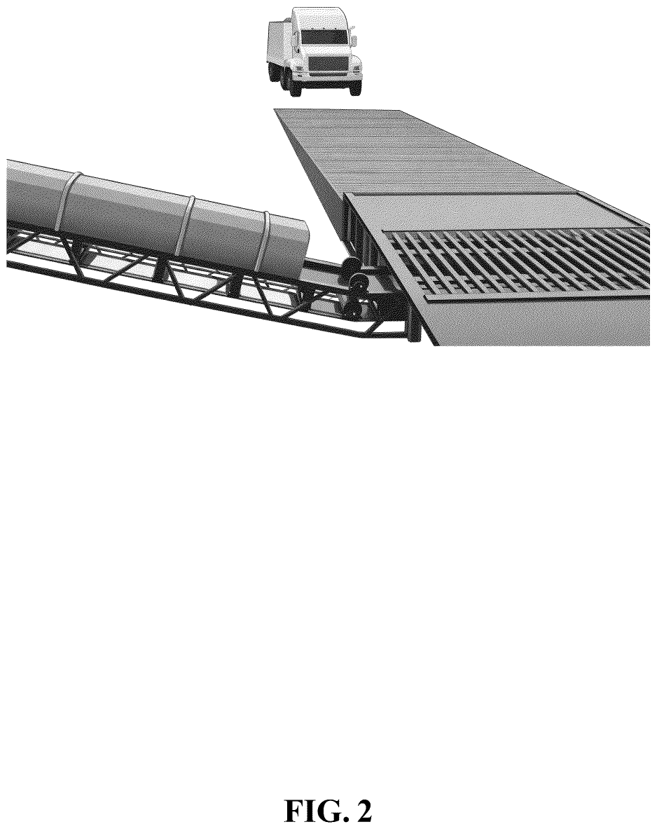

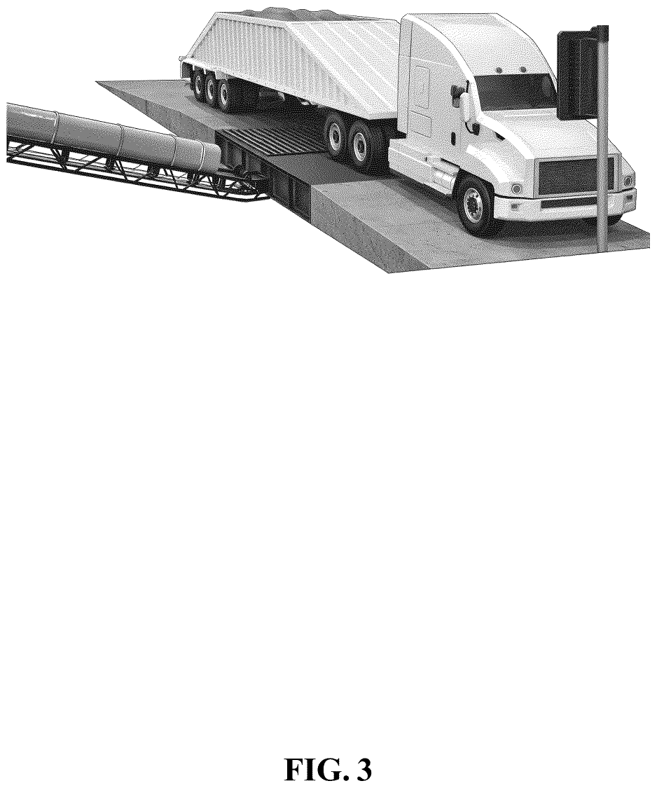

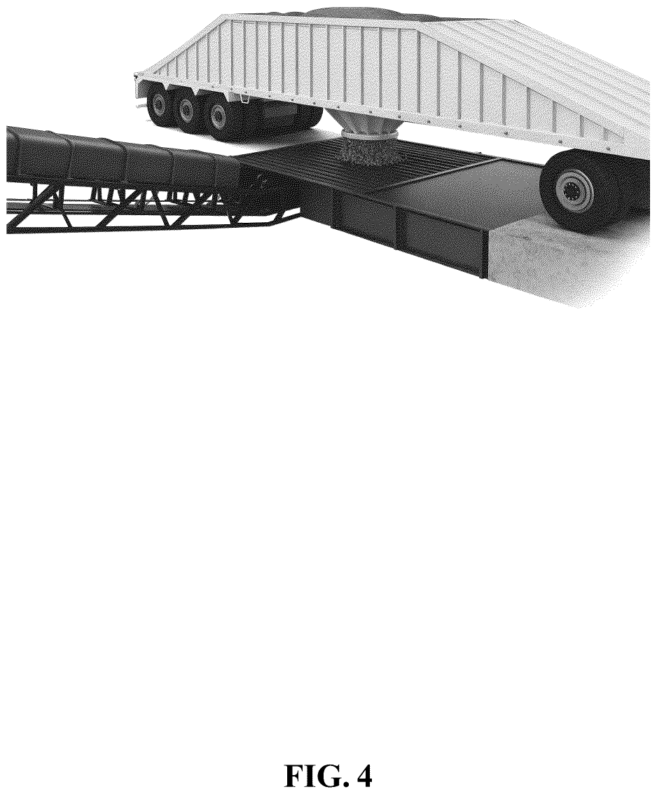

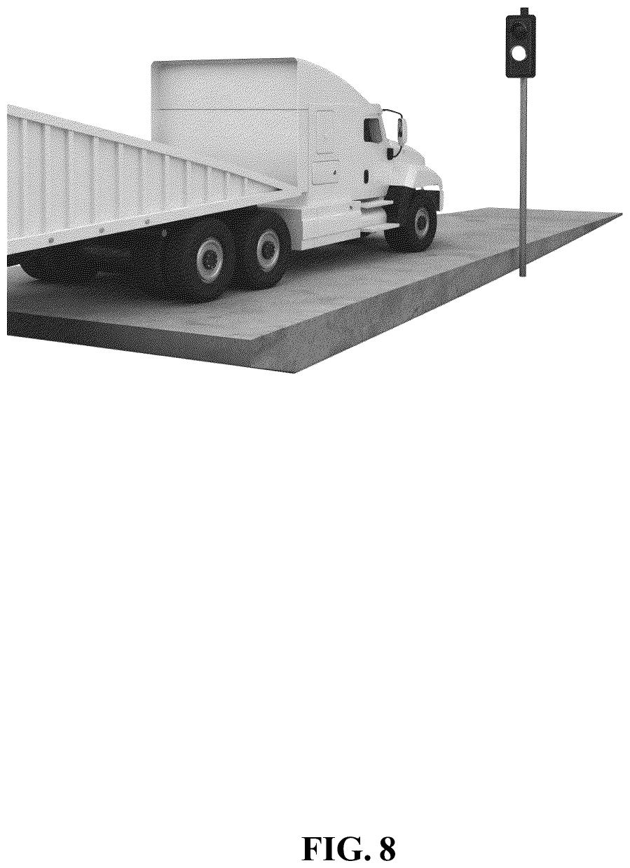

The systems and methodologies disclosed herein may be further appreciated with respect to the particular, non-limiting embodiment depicted in FIGS. 1-9, which disclose a system for unloading particulate goods from a belly dump trailer into a plurality of containers in accordance with the teachings herein. As seen in FIG. 1, the system 101 comprises an unloading dock 103 which may be, for example, a cement or asphalt roadway adapted to support the weight of heavy trucks. As seen in greater detail in FIGS. 2-4, the unloading dock is a roadway 105 with a built-in grate 107 which is adapted to receive particulate goods unloaded from a belly dump trailer 109.

Referring again to FIG. 1, the roadway is equipped with a traffic light 111 to indicate to the driver of the belly dump trailer 109 when the belly gates of the belly dump trailer 109 are properly positioned over the built-in grate 107 (red light) so that unloading may commence, and when unloading is complete (green light) and the truck may move forward.

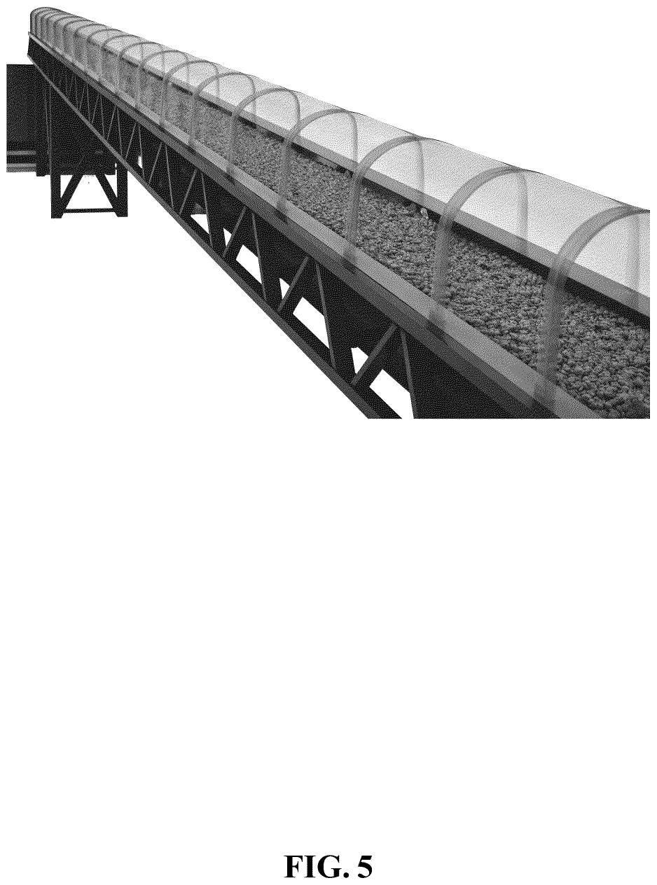

The system is further equipped with a series of conveyor belt systems which, in the particular embodiment depicted, consists of first 121 and second 123 conveyor belt systems. The first 121 and second 123 conveyor belt systems are arranged in series such that the output of the first 121 conveyor belt system feeds into the input of the second 123 conveyor belt system. This allows product to be efficiently moved (see, e.g., FIG. 5) from the grate to the output of the second 123 conveyor belt system.

The conveyor systems 121, 123 are powered by a generator unit 113. Several types of generator units may be used for this purpose. For example, the generator may be a conventional diesel, gasoline, or natural gas powered generator, or may be an electric (e.g., grid-tied) or hybrid generator.

The input of the first 121 conveyor belt system is positioned under the grate 107 in the roadway 105. The input is typically a hopper which is preferably funnel-shaped, with a wide top opening for receiving materials and a narrow bottom outlet for controlled discharge onto the conveyor belt. In some embodiments, the hopper may be releasably attached to the sides of a well built into the roadway to prevent the occurrence of any gaps that might lead to product spillage or waste.

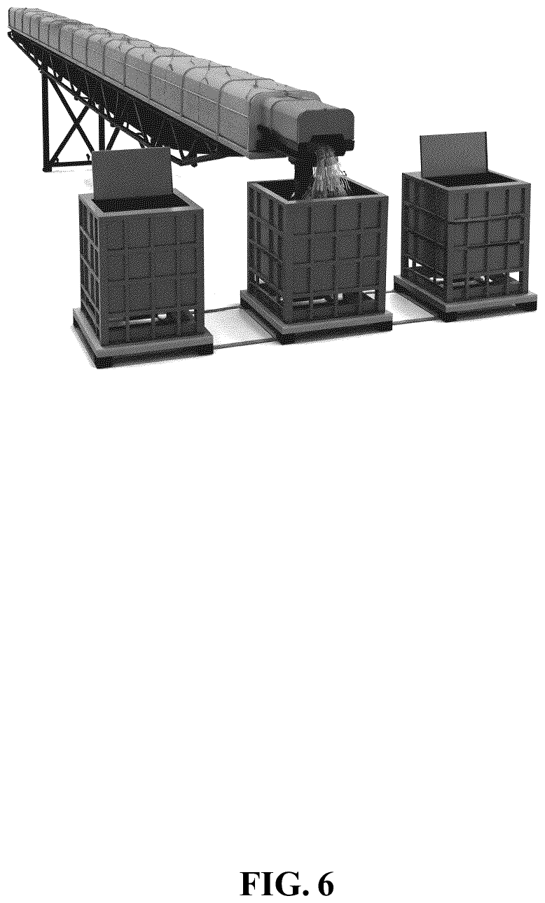

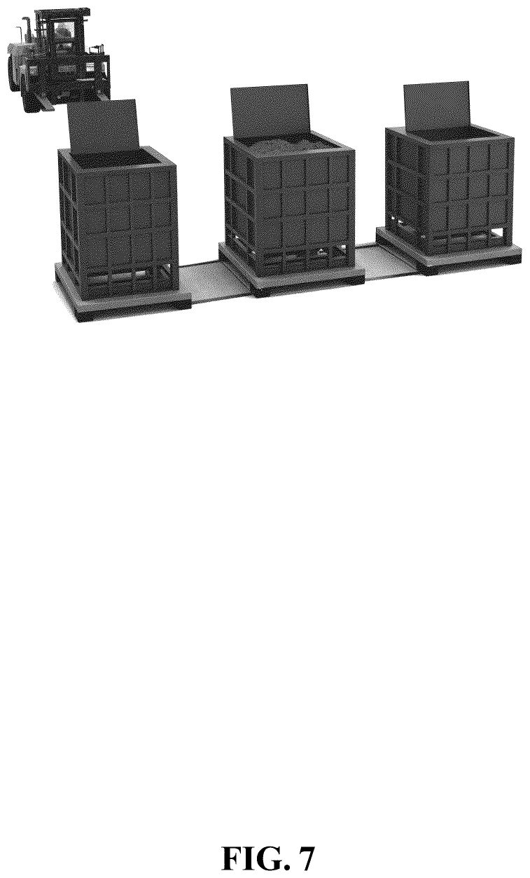

The system is preferably adapted to selectively direct product from the output end of the second conveyor belt system 123 into any of a plurality of containers 131 (see FIGS. 6-7). This may be accomplished in several ways. In some embodiments, the second conveyor belt system 123 may be rotatable with respect to the first conveyor belt system 121 to allow it to address any of a plurality of containers 131. For example, the second conveyor belt system 123 may be equipped with wheels, and possibly a built in motor, to allow the orientation of the second conveyor belt system 123 with respect to the first conveyor belt system 121 to be adjustable.

In other embodiments, the second conveyor belt system 123 may be equipped with an adjustable chute. For example, the chute may include a portion of flexible tubing which may be moved from one container 131 to another.

In still other embodiments, the containers themselves may be simply repositionable such that they can be interchanged after they are full. For example, in such embodiments, the containers may be positioned on movable dollies, or on a conveyor belt system of tracking.

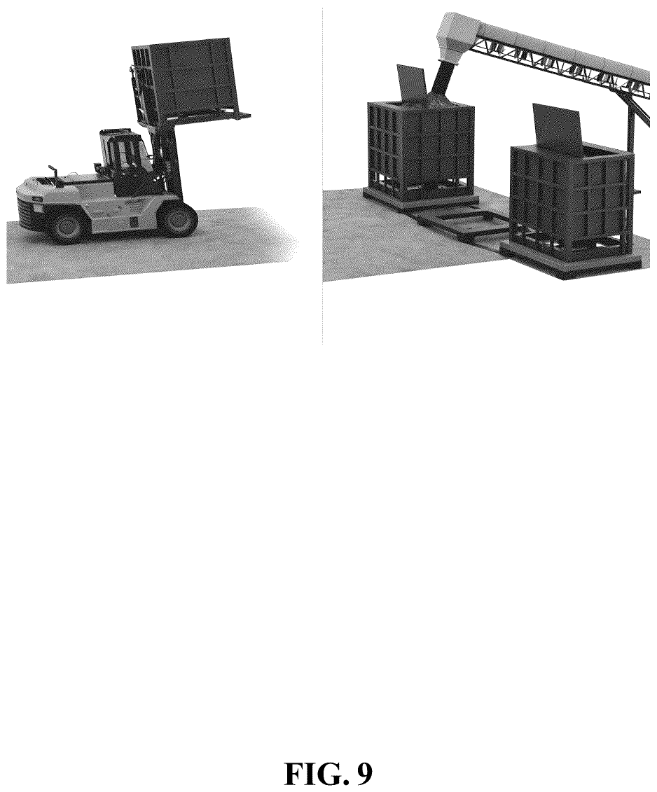

Referring again to FIG. 1, the containers 131 are disposed on a loading dock 141, which includes a suitable platform or roadway. In some embodiments, the containers 131 may be disposed on pallets 143 to allow them to be readily relocated with forklifts 145 (see FIG. 9).

It will be appreciated from the foregoing that the system 101 depicted in FIGS. 1-9 allows product to be delivered by a belly dump trailer 109 into the built-in grate 107 of the roadway 105 in the unloading dock 103. From there, the product is conveyed to a series of containers 131 on the loading dock 141 by way of one or more conveyor belt systems 121, 123.

In the illustrated embodiment, the roadway-integrated grate is preferably dimensioned and reinforced to accept full-load axle weights while providing sufficient open area to pass the anticipated particle size distribution without bridging. The grate spans a sump that funnels material to a hopper at the receiving end of the first conveyor. Replaceable bar panels or slotted plates may be selected based on commodity and cleaning requirements, and impact shelves may be provided within the sump to dissipate drop energy to reduce liner wear. Wheel guides, painted stop lines, and the traffic light cooperate to position the trailer precisely over the grate, minimizing spillage at the moment the belly gates open.

The traffic signal may be tied to permissive logic that verifies system readiness before authorizing discharge. For example, the controller may require confirmation that the first and second conveyors are running, the hopper level is below a threshold, the dust-collection hood is active (where provided), and access doors around the sump are closed. Only then does the signal transition to a “ready to unload” indication. After a target weight or hopper level is reached (or after a defined dwell time to clear residual material), the signal returns to “complete,” prompting the driver to move forward. Local beacons and an audible annunciator may be utilized to reinforce status where line-of-sight is obstructed.

The first conveyor beneath the grate is configured as a rugged intake stage. A funnel-shaped hopper with skirt seals, impact bars, and abrasion-resistant liners confines fines and protects the belt during high-energy dumps. The discharge of the first conveyor is arranged for a short, centered free-fall into the receiving end of the second conveyor, optionally guided by adjustable skirts to tune trajectory for different materials. The second conveyor serves as a placement/distribution stage; it may incorporate variable speed for rate control and an orientable discharge geometry to address multiple containers without relocating upstream equipment.

Power may be furnished by a dedicated generator set mounted on a skid or pad adjacent to the dock, or by plant power where available. In generator-fed installations, the package can include a weather enclosure, sound attenuation, and an automatic transfer/parallel capability for continuous operation. Hybrid arrangements are contemplated in which a grid-tied source supports steady loads while an engine-driven generator or battery inverter bank handles peaks during truck unload cycles. Centralized power distribution feeds local drives, dust-collection fans, and auxiliary loads (lighting, heaters, instrumentation) through quick-connect harnesses to simplify installation and maintenance.

The distribution end can be implemented in several interchangeable ways to direct product into a plurality of containers. In a mobile-base variant, the second conveyor is mounted on a slewing pedestal or wheeled carriage with indexed detents corresponding to container positions; an operator re-aims the discharge between fills and locks the base in place. In a fixed-base variant, the second conveyor remains stationary while a modular discharge cassette (such as, for example, a telescoping chute, spiral chute for gentle descent, vibratory pan for metering, screw feeder for cohesive product, or a rotary joining conveyor that ejects at a selected azimuth) slots into a standardized pocket. The cassette approach allows rapid changes to flow behavior and discharge angle without disturbing frames, guards, or wiring.

Container handling at the loading dock is preferably organized for fast changeover. Containers may be staged on pallets to facilitate forklift removal, or on dollies running in floor tracks that register each container beneath the discharge. Optional load cells beneath container stands provide weight feedback to terminate fills at target setpoints and to trigger an index to the next position. Telescoping spouts or adjustable drop sleeves can be fitted to minimize drop height and dust, and dust-tight quick-clamp hoods may bridge between the discharge and container in regulated environments.

Environmental and safety provisions may be integrated throughout. A retractable hood over the grate can connect to a dust collector via quick-clamp ducting; misting nozzles at impact points may be used where moisture addition is permissible. Interlocked access panels around the sump and transfer region prevent entry while the belts are in motion, and trapped-key or solenoid latches can require a verified coast-down and purge before opening. In cold climates, perimeter heat tracing or hydronic coils may be utilized to reduce freezing at the grate; in wet conditions, a dewatering sump with debris screens manages stormwater without interrupting material flow.

Instrumentation supports reliable operation and diagnostics. Typical sensors include trailer-presence detection near the grate, hopper level, belt tracking and speed, motor current/torque, dust concentration, and door interlocks. Where recipe-driven routing is used, the controller exposes a consistent set of commands and status tags for each module; upon detecting a cassette or a mobile base position, it loads parameters, coordinates setpoints, and presents appropriate controls on the HMI. A short built-in test (for example, jogging the belts, checking sensor transitions, and verifying current draw) may be executed at shift start or after maintenance to confirm readiness.

Collectively, the embodiment of FIGS. 1-9 creates a compact, high-throughput path from truck to container bank. The roadway grate captures the discharge precisely at the source; the intake conveyor buffers and stabilizes flow; the distribution conveyor (or interchangeable discharge cassette) places material accurately into selected containers. Since the mechanical datums, power/controls connectors, and discharge interfaces are standardized, the installation can be adapted over time to new materials, container heights, and throughput targets by exchanging modules or re-indexing the discharge, without field cutting, welding, or re-programming.

Various additions or modifications may be made to the systems and methodologies disclosed herein without departing from the scope of the present disclosure.

In some embodiments, a single conveyor belt provides both reception from the source and delivery to the destination. A single-belt configuration is suited to compact sites where the source discharge and target container bank are within a common elevation envelope. The belt may run beneath a receiving grate or hopper and terminate at an adjustable discharge spout or aimable chute. Discharge geometry (height, angle, and reach) can be varied by telescoping a short chute, pivoting a spout, or mounting the terminal section on a slewing bracket. This arrangement minimizes moving parts and power drops while preserving accurate placement into one or more receptacles positioned within the reachable sector of the discharge.

In preferred implementations, two conveyors are used to decouple reception dynamics from placement dynamics. A first conveyor is optimized for impact and surge absorption at the truck interface (using impact idlers, wear liners, skirts, and other suitable provisions) while a second conveyor is optimized for precision placement at the container interface (using variable-speed drives, adjustable elevation, repositionable discharge geometry, and the like). The division allows steady operation at the receiving end even when the placement end is indexing between containers or pausing to complete a fill cycle. Controls may coordinate the belts so the first conveyor buffers flow while the second executes a short stop/start or angle change, maintaining overall throughput.

In other embodiments, more than two conveyor belts may be employed to traverse longer distances, negotiate elevation changes, or serve multiple destination zones. A three-belt system, for example, may combine: (i) a low-profile intake belt beneath the source grate, (ii) an elevating or truss belt to clear site obstacles or climb to mezzanine height, and (iii) a distribution belt that slews or shuttles to address a plurality of containers. Additional belts may be added as “branch lines” to serve parallel container bays, railcars, stockpiles, or processing equipment. Junctions between belts can be implemented by direct gravity transfers, modular cassette adapters (e.g., spiral or telescoping chutes), or active devices (e.g., vibratory pans, screw feeders, or rotary joining conveyors) selected according to material properties and desired metering accuracy.

A modular approach allows the number of belts to be scaled without redesigning the entire installation. Base frames share standardized datums and bolt patterns so an intake belt can be paired with either a single adjustable discharge or, when needs evolve, a second and third belt added for elevation and distribution. Electrical and controls interfaces remain consistent, enabling additional belts to be inserted as networked modules that self-identify to the controller and expose uniform command and status tags. Recipes can then select among available paths (for example, “single-belt direct drop,” “two-belt buffered transfer,” or “multi-belt elevation and distribution”) based on product, throughput target, or container layout.

Selection among single-, dual-, and multi-belt configurations may be driven by site geometry, material behavior, and operational objectives. Single-belt systems favor minimal footprint and low capital cost where drop distances are small and container targets are fixed. Two-belt systems provide robust buffering and precise placement when the intake and discharge tasks are functionally distinct. Multi-belt systems address complex routing, large elevation deltas, or multiple destination zones while keeping each belt tailored to a specific role (impact, elevation, distribution). Across all variants, the transfer interfaces are designed to preserve flow continuity, control dust, and protect material integrity, so the system can be right-sized initially and expanded later as requirements change.

In some embodiments, flat belt conveyors are employed where a smooth carrying surface is desirable to minimize product degradation and spillage. Flat belts may run on slider beds for short, clean transfers or on closely spaced return rollers for reduced friction at longer runs. Skirts, impact bars, and belt cleaners can be fitted at the loading zone to control dust and manage wear. Flat belts integrate readily with modular cassette adapters (e.g., gravity or spiral chutes) because their discharge stream is predictable across a range of speeds.

Cleated belt conveyors may be used to maintain positive traction on inclines or to prevent rollback of coarse or irregular particles. Cleats (e.g., straight, scoop, or L-type) are bonded or molded to the belt at regular intervals and may be combined with sidewalls to form pockets. Cleated sections are advantageous for elevating material from the intake grate to a higher distribution belt or container without excessive drop height, and can be paired with variable-speed drives for controlled metering.

Trough belt conveyors (two-idler or three-idler troughing sets) are suitable for higher capacities and longer centers. The troughed profile increases cross-sectional area and helps center the load, reducing edge spillage. Impact idlers and wear liners may be provided beneath the loading zone; transition idlers at head and tail preserve belt life. Trough belts are well suited for the buffered “first conveyor” role, accepting truck surges and delivering a stabilized stream to a downstream placement conveyor.

Modular plastic belt conveyors (interlocking plastic links on sprockets) may be used where corrosion resistance, drainage, or frequent sanitation is required. Open-area link designs facilitate wash-down; solid-top links support small particles. Modular belts can incorporate flights or sideguards formed from the same material for gentle elevation and containment. Tool-less pin extraction supports rapid maintenance and changeover without disturbing the surrounding frames.

Wire mesh conveyors (woven wire or balanced-weave belts) are appropriate for high-temperature, drying, or cooling applications where airflow or heat transfer through the belt is advantageous. Mesh selection (pitch, wire gauge, weave) is tuned to particle size to prevent leakage while minimizing carryback. Edge chains or guard rings can be added for tracking; scraper or brush stations at the return remove fines that lodge in the weave.

Chevron belt conveyors utilize molded V-shaped profiles that improve grip on steep inclines and shed water or fines to reduce hydroplaning. Chevron patterns are beneficial where space constraints require aggressive elevation without resorting to cleats and sidewalls, preserving a simpler discharge geometry for alignment with cassette adapters.

High-temperature-resistant conveyors may be specified when handling hot product or operating near heat sources. Belts may be constructed from heat-resistant rubbers, silicone-glass composites, PTFE-coated fabrics, or metal belts, and can incorporate thermal barriers or air-gap guards to protect bearings and sensors. Components exposed to heat (idlers, scrapers, skirts) are selected accordingly, while the external interfaces—bolt patterns, datum faces, and connector positions—remain identical for interchangeability with standard modules.

Roller bed conveyors (live roller beds under the carrying strand) reduce drag and energy consumption on long, level runs or where high throughput is required. Roller beds are compatible with both flat and chevron belts and can be segmented for zone control—useful when coordinating with downstream metering or indexing operations. Return-run rollers and belt plows may be included to minimize carryback.

The foregoing conveyor types may be mixed and matched within a system to meet site-specific goals (for example, a trough belt at intake for surge tolerance, a cleated or chevron belt for elevation, and a flat or modular plastic belt for precise container placement). Across all types, the mechanical interfaces (mounting datums, envelope dimensions) and electrical/controls interfaces (quick-connect harness, unified tag set) are preserved so any conveyor module can be substituted or upgraded without reworking adjacent frames, utilities, guards, or software. Additional conveyor technologies (such as corrugated-sidewall belts, en-masse drag chains, or air-slide bridges) may also be employed where appropriate, without limitation, while maintaining the same standardized interfaces for modular integration.

In some embodiments, the conveyor is configured for inclined or declined operation to accommodate elevation changes between a source and a destination. Inclined systems may employ cleated or chevron belts and optional sidewalls to maintain traction and contain rollback on slopes (for example, 10-35° depending on material). Declined systems can be fitted with brake-assisted drives or dynamic braking to prevent overspeed under gravity, and may incorporate cascade baffles or spiral chutes at the discharge to reduce impact energy. Transition zones at the head and tail may include lengthened take-ups and profile transition idlers to protect belt carcasses when moving between flat and troughed sections. Where headroom is limited, compact nosebars or short-radius end rollers support close transfers to downstream equipment.

In other embodiments, the conveyor follows a curved belt path to navigate around structural columns or to fan discharge toward multiple receptacles without intermediate handoffs. Curved systems may use segmented slider beds or conical rollers to guide the belt along a controlled radius while maintaining edge tension balance. Guide shoes or side skirts can be profiled to the curve to minimize spillage, and belt tracking is maintained by crowned pulleys or automatic edge-sensing trackers. Curved sections can be combined with elevation changes (helical or compound curves) where the site footprint is constrained, and may be furnished with clean-out doors and inspection ports at curve apexes to facilitate housekeeping.

Multi-stage configurations may be used where a single conveyor cannot satisfy distance, elevation, or routing requirements. In a multi-stage conveyor system, a first stage near the source is optimized for impact absorption and surge buffering, a second stage manages elevation (for example, via cleated or sidewall belts), and a third stage provides precision placement or distribution (for example, via a slewing or shuttling discharge). Stages can be physically decoupled by modular transfer cassettes (gravity chutes, spiral chutes, vibratory pans, screw feeders, or rotary joining conveyors) selected to suit the handled material and the desired metering behavior. Each stage may be sized for its duty (belt width, speed, trough angle), with standardized mechanical and electrical interfaces so stages can be added, removed, or re-ordered as process needs evolve.

In preferred implementations, conveyors are adjustable speed to match variable production rates, manage fill cycles, and coordinate with upstream or downstream equipment. Speed control may be provided by variable-frequency drives (VFDs) or servo drives with ramp profiles that limit inrush current and belt tension spikes. Closed-loop regulation can reference mass-flow feedback inferred from load cells, motor torque, or encoder data, holding a target throughput despite changes in bulk density. Supervisory logic may coordinate speed schedules across multiple stages, for example, slowing the intake belt while a downstream container indexes, or accelerating an elevation belt to clear surge from a truck unload without overfilling the distribution zone. Soft-start, anti-rollback (for inclines), and jam-detection thresholds can be parameterized per recipe.

In certain embodiments, conveyors are provided as customizable modular systems built from standardized frame sections, leg kits, drive modules, and transfer cassettes. Frames expose common datum faces and bolt patterns so straight, curved, and elevating sections can be combined without custom fabrication. Leg assemblies provide telescopic height and lateral adjustment to set drop geometry, while one-plug electrical harnesses connect power, control, and communications to each module for plug-and-play commissioning. Transfer cassettes—gravity, spiral, telescoping, vibratory, screw, or rotary joiner—share a common envelope and latch into a pocket between stages so flow behavior, discharge angle, and metering can be altered in minutes without disturbing adjacent frames or utilities. Hygienic, abrasion-resistant, and high-temperature material packages can be swapped while preserving the same exterior interfaces to maintain interchangeability across environments.

Across these configurations (inclined/declined, curved, multi-stage, adjustable speed, and modular), the systems may incorporate safety and service features that preserve uptime and compliance. Examples include trapped-key or solenoid interlocks at access points, emergency-stop and light-curtain integration via a common safety bus, dust-containment hoods with quick-clamp ducting, and condition monitoring (vibration, temperature, torque, dust concentration) surfaced through a unified tag set to the controller and HMI. The result is a configurable conveyor platform that can be right-sized to current site geometry and material properties and then re-tooled over time as throughput targets, discharge geometries, or regulatory requirements change, without re-engineering the surrounding installation.

In some embodiments, flat conveyor belts are used for general-purpose transport where a smooth, continuous carrying surface minimizes degradation and spillage. Flat belts may operate on slider beds for compact runs or on roller beds for reduced drag over longer distances. Loading zones can incorporate impact bars, wear liners, and skirt seals; discharge ends may use crowned pulleys or automatic trackers to maintain alignment. Suitable belt carcasses include polyester-nylon (EP) or aramid for higher tension, with top covers formulated for abrasion or oil resistance. Scraper assemblies and wash bars may be fitted to reduce carryback, and splice choices (mechanical, hot-vulcanized, or finger) are selected to match sanitation and duty requirements.

For inclined movement, cleated conveyor belts may be specified to prevent rollback. Cleats can be straight, scoop, or L-type, with heights chosen to match particle size (e.g., 25-75 mm) and pitches tuned to the desired throughput. Sidewalls can be added to form pockets for steep lifts, and anti-rollback devices or backstops may be integrated at the head pulley. Drive profiles can include soft-start ramps to limit belt tension spikes on heavy starts, and drop heights into cleated sections are minimized with nosebars or short-radius end rollers to protect fragile product.

For demanding or frequently reconfigured lines, modular plastic belt conveyors provide durability and adaptability. Interlocking links ride on sprockets, so belt width, open-area, and flight geometry can be reconfigured without replacing the frame. Open-grid modules support drainage and cooling; solid-top modules carry fines without sifting. Materials (PP, PE, acetal, PBT) are matched to temperature and chemical exposure, and tool-less hinge pins expedite sanitation or field repair. Modular belts integrate well with cassette-style transfer adapters because their discharge trajectory is consistent across speeds.

Where higher capacities or longer centers are required, trough belt conveyors (two-or three-idler) increase cross-sectional area and naturally center the load. Transition idlers at head and tail protect the carcass, and impact-rated idlers under the loading zone absorb drop energy. Trough angles (e.g., 20-35°) are selected to balance capacity and belt stress, while enclosure hoods and dust skirts reduce emissions during transfer. Trough belts are well suited as intake/buffer stages feeding an elevating or distribution belt downstream.

Certain applications benefit from wire mesh conveyor belts, which provide ventilation, drainage, and heat tolerance. Balanced-weave or compound-balanced meshes can be specified for particle retention and tracking stability. Where fine product might lodge in the weave, return-run brushes or spray bars may be provided. Mesh belts are appropriate for dewatering sand or recycled plastics and for high-temperature processes when paired with insulated guards and heat-rated bearings.

Chevron conveyor belts employ molded V-patterns that improve grip on steep inclines and shed water or fines to avoid hydroplaning. Chevron profiles are advantageous when space limits preclude cleats and sidewalls, preserving a simpler discharge geometry for alignment with fixed chutes, spiral cassettes, or rotary joining conveyors. Pattern selection (height, pitch) is tuned to the material's angle of repose and the target slope.

For hot or thermally aggressive service, high-temperature-resistant belts may be used. Depending on duty, these can include heat-resistant rubber compounds, silicone-glass laminates, PTFE-coated fabrics, or all-metal belts. Thermal shields, air gaps, and reflective guards can be incorporated to protect frames, sensors, and seals. Where thermal cycling is expected, expansion joints and floating take-ups may be specified to maintain tracking and tension.

In some lines, roller bed conveyors are preferred to reduce friction and energy consumption on long, level runs or where high throughput is required. Roller zones can be segmented for dynamic accumulation or coordinated with downstream metering, and belt plows on the return strand minimize carryback.

Across belt types, selection may be guided by particle size distribution, friability, moisture content, bulk density, required slope, sanitation class, ambient/commodity temperature, and abrasion index. The systems disclosed herein maintain standardized mechanical datums and quick-connect electrical/controls interfaces so that flat, cleated, trough, modular plastic, wire mesh, chevron, high-temperature, and roller bed conveyor modules can be interchanged without reworking adjacent frames, utilities, guards, or software. As materials, throughput targets, or regulatory conditions evolve, the belt technology can be swapped or upgraded while preserving discharge geometry and control tags, enabling efficient, reliable handling of diverse particulate materials across industries.

In various implementations, the intake interface is adapted to the vehicle and roadway in use while preserving the downstream conveyor architecture. For paved facilities, the receiving grate may be integrated into a reinforced concrete or asphalt slab with a flush, wheel-rated frame so vehicles can pass directly over the opening. The grate spans a sump sized to the peak discharge rate of the vehicle class, with splash baffles and wear liners that direct flow into the first conveyor's hopper. Alignment aids—painted stop lines, wheel guides, and a pole-mounted traffic signal—assist operators in positioning the discharge gates over the grate before opening. The control system may enforce permissives (for example, belts running, hopper level below threshold, dust collector active) before enabling the vehicle's discharge sequence.

Although belly dump trailers offer the most direct gravity discharge, other vehicle types can be serviced with tailored adapters. Side-dump and end-dump trailers may tip into a curbed receiving pocket that funnels material laterally into the grate; the pocket may be lined and shaped to prevent roll-back and to dissipate impact energy. Walking-floor trailers and agricultural spreaders can meter directly into a low-profile intake hopper spanning the lane, with adjustable skirts to capture discharge width. Hopper-bottom grain trailers can be serviced by a narrow central slot grate with tapered aprons that guide the stream to the belt centerline. Pneumatic tankers may fluidize and blow fine powders into a sealed receiver above the grate; a rotary air-lock meters product into the conveyor while maintaining negative pressure for dust control.

For off-highway applications, dump trucks, front-end loaders, skid steers, and mining haul trucks can discharge into oversized intake hoppers positioned at grade or in shallow pits. Where ground conditions preclude permanent civil work, the grate and hopper may be supplied on a skid or modular steel deck with integrated ramps, wheel loads distributed through cribbing or helical piles. Optional rock boxes and impact shelves reduce wear from large lumps. In cold climates, heat tracing or hydronic coils embedded around the grate mitigate freezing; in wet climates, dewatering sumps and bar screens manage rainwater and debris without interrupting material flow.

The roadway integration can be mirrored in rail environments. A dedicated track panel incorporates a wheel-rated grate between the rails, supported by a pit frame that transfers load to adjacent ties or concrete corbels. Belly-dump railcars align their longitudinal gates over the grate; side chutes or diverter pans can be added for gondolas or rotary-dump cycles to direct material toward the intake. Clearance envelopes are respected by placing conveyor drive components below the subgrade and by recessing hatch covers flush with the ballast line. Rail-specific permissives—track occupancy detection, derails in the protected position, blue-flag interlocks—are tied into the intake controls so dumping cannot begin unless the pit is ready.

Dust and environmental containment are adapted to the transport mode. For road vehicles, a hinged or telescoping canopy may deploy over the grate during discharge, connected by quick-clamp ducting to a dust collector; the canopy footprint accommodates the turning radius and axle spacing of expected vehicles. For rail, a retractable hood spans car hatches or under-gate openings, with flexible skirts sealing to the car body during dump. In both cases, negative pressure at the grate, combined with atomizing sprays or fogging at impact points where appropriate, suppresses fugitive dust without wetting the product more than the process allows.

Weighing and traceability can be integrated at the intake regardless of vehicle type. Road scales embedded ahead of and behind the grate support in-out weighing for trucks and trailers; rail scales (static or in-motion) can be installed on the approach track. The control system associates weight tickets, vehicle IDs (RFID or camera-read plates), and product recipes with the unloading cycle, then governs downstream routing—e.g., directing to specific containers, stockpiles, or rail-to-road transfer belts—based on order data. Where multiple sources arrive in sequence, the first conveyor can act as a surge buffer while the routing logic completes the prior fill, preventing cross-contamination.

For remote or temporary campaigns (road construction, disaster response, seasonal harvest) the intake may be supplied as a portable kit. A towable skid carries the grate, hopper, first conveyor, generator, and dust collector; fold-down ramps and adjustable jacks level the unit on uneven ground. Quick-connect harnesses and modular transfer cassettes (gravity, spiral, vibratory, screw, rotary joiner) allow the same portable intake to feed a variety of downstream configurations, from a single discharge belt to a multi-container distribution node, without on-site fabrication.

Across these roadway and rail adaptations, the mechanical datums, utility connectors, and software interfaces remain standardized so the upstream intake variant—belly dump trailer, end dump, side dump, walking floor, hopper bottom, pneumatic tanker, loader bucket, belly-dump railcar—can be swapped or upgraded without re-engineering the downstream conveyor stages. This preserves the core advantages of the disclosed system: rapid changeover among transport modes, minimal civil disruption beyond the intake pocket, controlled dust and spillage, and deterministic hand-off from vehicle to conveyorized flow.

In some embodiments, the disclosed systems and methodologies are configured to accommodate the physical and regulatory demands of disparate particulate products and aggregates while preserving a common modular architecture. The selection of conveyor type (e.g., flat, cleated, trough, modular plastic, wire mesh, chevron, high-temperature), transfer cassette (e.g., gravity, spiral, telescoping, vibratory, screw, rotary joiner), and environmental package (e.g., dust-tight, hygienic, high-temperature, abrasion-resistant) may be tuned per industry without altering standardized mounting datums, utility connectors, or control interfaces. In this way, a single base platform can be re-tooled for new feedstocks, throughput targets, and discharge geometries with minimal redesign.

For construction materials such as gravel, sand, asphalt millings, and hot-mix asphalt, impact-tolerant intake zones (impact bars, wear liners, heavy-duty skirts) and high-throughput trough belts may be paired with abrasion-resistant cassettes and dust-collection hoods at transfer points. Where hot product is handled, high-temperature belt sections and refractory-lined cassettes protect structure and bearings while maintaining drop geometry. Portable grate-and-conveyor skids enable rapid set-up at paving sites, quarries, or staging yards; recipe-level routing can direct different gradations to dedicated containers or stockpiles to reduce cross-contamination.

In agricultural settings, gentle handling and contamination control are prioritized for bulk grains, oilseeds, meals, and fertilizers. Modular plastic belts, spiral or telescoping chutes, and vibratory cassettes can be combined to limit kernel damage and segregation. Hygienic material packages (with stainless frames, smooth welds, tool-less liners, and clean-in-place spray bars) may be utilized to support sanitation requirements. Hopper-bottom trailers can discharge through narrow slot grates with guided aprons; mass-flow feedback from load cells or torque-inferred soft sensors maintains even distribution to bins or tender trucks. Traceability features (lot IDs, in/out weights, recipe logs) integrate with elevator or co-op inventory systems.

For mining and mineral processing, robustness and containment dominate. Intake pockets with rock boxes and AR/ceramic-lined cassettes withstand large, angular lumps and high drop energy. Sealed drag-style cassettes, screw feeders, or rotary joiners can meter abrasive ore, coal, or concentrates into downstream belts at controlled rates, while negative-pressure dust enclosures and fogging at impact points mitigate respirable dust. Multi-stage layouts traverse elevation deltas from pit to plant; standardized interfaces allow insertion of magnets, metal detectors, or sampler cassettes without structural rework.

In cement, gypsum, lime, and related industrial sectors, the platform addresses both powder and coarse fractions. Air-slide bridges can transfer fine powders between belt stages without moving parts, and rotary air-lock cassettes maintain pressure balance to mills, kilns, or pneumatic lines. For limestone or clinker, high-temperature or chevron belts handle hot, friable material with reduced rollback; thermal breaks and heat shields protect sensors and drives. Recipe-driven routing orchestrates multi-silo distribution, and uniform function blocks expose consistent alarms (plugging, over-temp, dust) across cassette types to simplify plant operations.

Recycling operations benefit from adaptability to heterogeneous feed (crushed glass, shredded plastics, metals, and fines). Interchangeable cassettes allow quick shifts between cushioned spiral descent for glass to minimize fines, magnetic transfer or eddy-current modules for metals, and wire-mesh or dewatering sections for wet regrind. Enclosures with quick-clamp ducting and viewports maintain visibility and dust control during frequent changeovers. Condition monitoring (vibration, torque, temperature, dust concentration) surfaces through a standardized tag set to flag wear, wrap, or jam conditions early, reducing downtime in high-mix, high-variability streams.

Across all industries, safety and compliance are integral. Trapped-key or solenoid interlocks, e-stop and light-curtain networks, lockable energy isolation, and dust-containment canopies are packaged as dockable submodules that carry over between applications. Weighing, identification (RFID or vision), and audit-grade logging tie vehicle or rail intake events to downstream routing and container fills for accountability. Because mechanical datums, utilities, and software interfaces remain constant, the same installation can be reconfigured over its life to handle new products, meet evolving environmental or hygiene standards, and scale throughput by exchanging cassettes or inserting additional belt stages rather than rebuilding the transfer tower—enhancing operational effectiveness while controlling capital and maintenance costs.

In industrial loading docks, the system can be integrated with fixed pits and wheel-rated grates embedded in reinforced slabs, feeding a first conveyor beneath dock level and a distribution conveyor that slews or shuttles to multiple bays. Quick-connect dust hoods, dock bumpers, traffic lights, in-out scales, and RFID vehicle identification may be tied to permissives so unloading cannot begin unless belts, collectors, and guards are in a ready state. Cassette-style transfer adapters (gravity, spiral, vibratory, screw, rotary joiner) allow the same dock pocket to handle different commodities and container heights without structural changes.

At construction sites, a portable configuration may be preferred. A skid-mounted grate, hopper, first conveyor, generator, and dust collector can be leveled with jack stands and connected by one-plug harnesses. Telescopic legs and slide rails tune discharge elevation and skew as staging changes; abrasion-resistant liners, rock boxes, and impact bars protect the intake from large aggregate. For night or adverse-weather work, integrated task lighting and weather shrouds maintain visibility and containment while preserving the same mechanical and electrical interfaces as the fixed installation.

In agricultural yards, gentle handling and sanitation drive the configuration. Narrow slot grates accept hopper-bottom trailers; spiral or telescoping chute cassettes reduce drop energy into bins or tender trucks. Stainless or coated frames, tool-less liner removal, smooth welds, and clean-in-place spray bars support wash-down. Recipe-driven routing directs lots to specific bins; mass-flow feedback (from load cells or soft sensors) balances fill across multiple silos while dust hoods and aspiration maintain air quality.

For mining operations, robustness and containment dominate. Oversized grates with rock boxes, AR/ceramic-lined cassettes, and heavy trough belts absorb high-energy dumps from haul trucks or loaders. En-masse drag or screw cassettes meter cohesive ore, while negative-pressure canopies and fogging at impact points suppress respirable dust. Modular magnets, metal detectors, and sampler cassettes insert into standardized pockets without frame rework; high-temperature options handle clinker or calcined product with thermal breaks and refractory liners.

In urban transfer stations, footprint and emissions constraints are paramount. Low-profile intakes fit within height-limited bays; enclosed conveyors with quick-clamp ducting and HEPA or baghouse collectors minimize fugitive dust and odor. Sound-attenuated covers and vibration isolators reduce noise. The cassette pocket may host a rotary joining conveyor to redirect flow among compact container arrays at arbitrary azimuths without moving the main belts, enabling dense layouts.

At rail yards, a wheel-rated grate panel is integrated between rails over a conveyor pit, with the drives and maintenance access below subgrade. Belly-dump railcars discharge directly through the panel; gondolas can be serviced by auxiliary diverter pans. Track occupancy detection, derails, and blue-flag interlocks tie into the permissive logic. A slewing or shuttle distribution conveyor downstream loads stockpiles or intermodal containers; standardized pockets accept air-lock or air-slide cassettes where pneumatic interfaces are required.

Port facilities may employ high-throughput, corrosion-resistant variants. Stainless or coated frames, sealed bearings, and marine-grade electrics resist salt exposure. Shuttle or tripper distribution belts feed holds, barges, or yard piles; load-out spouts with telescoping sleeves interface to vessel hatches. Integrated weighing (belt scales or load cells) and moisture probes support contractual compliance, while unified function blocks expose consistent tags for terminal SCADA integration.

Warehouse and distribution centers can use the platform for bulk packaging or depalletization. Modular plastic or flat belts interface with form-fill-seal stations, super-sacks, or gaylords; cassette swaps change from free-flowing granules to fragile pellets without altering the frames or harnesses. Vision or barcode readers at the intake associate inbound lots with destinations; HMI pages auto-populate when modules are discovered on the network, simplifying recipe selection and maintenance.

Recycling centers benefit from rapid re-tooling for mixed streams. Spiral cassettes cushion cullet, magnetic transfer modules pull ferrous from fines, and wire-mesh or dewatering sections handle wet flake. Transparent inspection panels and interlocked doors facilitate jam clearance; standardized alarm causes (plugging, over-torque, dust) and health indices (vibration/torque envelopes) appear identically across mechanisms to speed diagnosis in high-mix operations.

Specialized industrial facilities—cement, gypsum, chemicals, foundries—can standardize on the same interface while selecting environment-specific packages: air-slides and air-locks for powders, high-temperature belts and refractory liners for hot product, or hygienic stainless variants for regulated materials. Across all settings, the common mechanical datums, cassette envelopes, utility connectors, and unified software blocks allow the installation to be scaled, re-routed, or upgraded with minimal downtime, engineering effort, or field fabrication.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. For convenience, some features of the claimed invention may be set forth separately in specific dependent or independent claims. However, it is to be understood that these features may be combined in various combinations and sub-combinations without departing from the scope of the present disclosure. By way of example and not of limitation, the limitations of two or more dependent claims may be combined with each other without departing from the scope of the present disclosure.

What is claimed is:

1. A system for unloading particulate materials from a belly dump trailer, comprising:
a roadway with a grate integrated therein;
a first conveyor system, including (a) a first receiving end positioned under the grate for receiving particulate materials, (b) a first discharging end, and (c) a first conveyor belt for conveying particulate materials from the first receiving end to the first discharging end;
a second conveyor system, including (a) a second receiving end positioned to receive particulate materials discharged from the first discharging end of the first conveyor system, (b) a second discharging end, and (c) a second conveyor belt for conveying particulate materials from the second receiving end to the second discharging end;
a plurality of containers configured to receive particulate materials discharged from the second discharging end of the second conveyor system; and
a rotational mechanism configured to rotate at least a portion of the second conveyor system along an axis to reposition the second discharging end of the second conveyor system over a selected one of the plurality of containers.

2. The system of claim 1, wherein the grate is releasably secured to the roadway.

3. The system of claim 1, wherein the first receiving end of the first conveyor system includes a hopper with a funnel-shaped design for guiding particulate materials onto the first conveyor belt.

4. The system of claim 1, further comprising a dust suppression system integrated with the grate, wherein said dust suppression system includes a set of misting nozzles to reduce airborne particulate matter during material discharge.

5. The system of claim 1, wherein the first conveyor system includes at least one sensor configured to monitor the flow rate and density of particulate materials being transported.

6. The system of claim 1, wherein the rotational mechanism includes a motorized control unit configured to automatically adjust the position of the second conveyor system based on the filling status of the plurality of containers.

7. The system of claim 1, wherein the second discharging end of the second conveyor system is equipped with a flexible discharge chute for precisely directing materials into containers.

8. The system of claim 1, wherein each container of the plurality of containers includes a weight sensor configured to provide real-time feedback on the amount of material received.

9. The system of claim 1, wherein the conveyor systems are powered by variable-speed motors configured to optimize energy consumption based on material load.

10. The system of claim 1, wherein the first and second conveyor belts are at least partially enclosed to minimize dust generation and environmental exposure during material transport.

11. The system of claim 1, further comprising a traffic light system configured to signal to a driver of the belly dump trailer when the trailer is properly positioned over the grate and when unloading is complete.

12. The system of claim 1, wherein the first and second conveyor systems include modular components that can be replaced or reconfigured to handle different types of particulate materials.

13. The system of claim 1, wherein the rotational mechanism of the second conveyor system allows for adjustments along both horizontal and vertical axes for enhanced container positioning.

14. The system of claim 1, further comprising a user interface configured to allow real-time monitoring and control of the conveyor systems, the rotational mechanism, and container status.

15. A method for unloading particulate materials from a belly dump trailer, comprising:
discharging particulate materials from the belly dump trailer onto a roadway with a grate integrated therein;
receiving the particulate materials through the grate at a first receiving end of a first conveyor system;
conveying the particulate materials from the first receiving end to a first discharging end using a first conveyor belt;
receiving the particulate materials at a second receiving end of a second conveyor system, the second receiving end positioned to receive particulate materials discharged from the first discharging end of the first conveyor system;
conveying the particulate materials from the second receiving end to a second discharging end using a second conveyor belt; and
selectively discharging the particulate materials from the second discharging end into each of a plurality of containers.

16. The method of claim 15, wherein selectively discharging the particulate materials from the second discharging end into each of a plurality of containers includes:
rotating at least a portion of the second conveyor system along an axis to reposition the second discharging end over a second of the plurality of containers; and
discharging the particulate materials from the second discharging end into the second of the plurality of containers.

17. The method of claim 16, wherein the second conveyor system has a longitudinal axis, and wherein rotating at least a portion of the second conveyor system along an axis to reposition the second discharging end over a second of the plurality of containers includes rotating the second conveyor system along its longitudinal axis.

18. The method of claim 15, wherein the second conveyor system is equipped with a flexible discharge tube, and wherein selectively discharging the particulate materials from the second discharging end into each of a plurality of containers includes selectively placing the discharge tube over each of the plurality of containers.

19. The method of claim 15, wherein the grate is releasably secured to the roadway.

20. The method of claim 15, wherein the first receiving end of the first conveyor system includes a hopper with a funnel-shaped design for guiding particulate materials onto the first conveyor belt.
